(19) United States
(12) Patent Application Publication
(10) Pub. No.: US 2021/0019369 A1
(43) Pub. Date: Jan. 21, 2021

(54) Context-Aware Video Subtitles

(71) Applicant: Adobe Inc., San Jose, CA (US)

(72) Inventors: Mrinal Kumar Sharma, Noida (IN); Gourav Singhal, Delhi (IN)

(73) Assignee: Adobe Inc., San Jose, CA (US)

(21) Appl. No.: 16/514,504

(22) Filed: Jul. 17, 2019

(51) Int. Cl. G06F 17/27; H04N 5/278; G10L 15/22

(52) U.S. Cl. CPC G06F 17/2775; G06F 17/2785; G06F 17/275; H04N 5/278; H04N 2005/44526; G06F 17/2795; G06F 17/2735; G06F 17/2715; G10L 15/22

(57) ABSTRACT

Generation of context-aware subtitles for a video is described. A subtitle context system receives video subtitles, extracts words from the subtitles, and determines a part of speech describing each word's use in the video. The subtitle context system then determines a difficulty score for each of the words based on the length of the word, a frequency with which the word is used in the language of the video, and a language proficiency score for a user viewing the video. To identify which words of the subtitles are likely difficult for the viewing user to understand, the subtitle context system compares the computed difficulty scores to a difficulty score threshold. For each word having a difficulty score that satisfies the threshold, a definition and one or more synonyms are ascertained. During video playback, the definition and synonyms for difficult to understand words are displayed concurrently with the word.

### BACKGROUND

Videos are an increasingly preferred medium for communicating messages to a wide range of users across different geographic locations. In contrast to conventional approaches of conveying messages simply via text, messages conveyed via video are more easily retained by a viewing user. A majority of videos are created in the language with which the video's creator is most comfortable. However, many viewing users may be unfamiliar with, or unable to understand, the language in which a video is created and thus unable to comprehend meanings associated with individual words, much less the video's overall intended message. Although some videos include audio that has been translated into a variety of different languages to reach a more diverse audience, translating audio remains a time-consuming process, with human intervention required to guide even the most sophisticated computer-implemented translation approaches.

To reach a wider audience without having to translate the video's audio, some conventional approaches add subtitles to the video, which textually describe dialog and other audible aspects during playback of the video. By reading these subtitles, users with impaired hearing, users who opt to watch the video without sound, and so forth can follow along and understand the video's message. Although translating video subtitles into different languages may require fewer computational resources than translating audio, conventional approaches for translating subtitles remain time-intensive and require human input. Additionally, watching a video translated from its original language does not assist a viewing user in learning or otherwise comprehending the original language of the video. Accordingly, viewing users who are not familiar with a video's source language and wish to view the video in its source language are often forced to pause the video upon encountering a word with which the user is unfamiliar. While the video is paused, the viewing user must navigate away from the video (e.g., open a dictionary, open a web browser to research the word, etc.), and return to resume playback of the video after ascertaining a meaning for the word. This process of pausing, researching, and resuming the video often causes users to lose interest in the video, interrupts the video creator's intended flow, and consequently decreases overall user engagement with the video.

Thus, conventional approaches to providing context for audible aspects of a video are unable to do so without disrupting playback of the video and require manual intervention on behalf of a viewing user to identify and research words with which they are unfamiliar, which consequently requires consumption of excessive amounts of network and computational resources.

### SUMMARY

Generation of context-aware video subtitles in a digital medium environment is described. A subtitle context system receives video subtitles, such as subtitles embedded in metadata of a video, and extracts words of the video subtitles into a text file that includes start and end timecodes indicating when respective ones of the words are to be output during playback of the video. In order to determine an appropriate context and convey appropriate meanings for words in the text file, the subtitle context system is configured to determine a part of speech tag for each word that describes the word's use in the video (e.g., whether the word “ducks” is being used as a noun or a verb).

Upon determining a part of speech tag for each word in the text file, the subtitle context system generates a difficulty score for each of the words. As described herein, the difficulty score for a given word in the text file is particular to a viewing user, such that generating difficulty scores for a single word may result in two different difficulty scores for two different viewing users. To generate a word's difficulty score, the subtitle context system considers a length of the word, a frequency at which the word is used in the language of the video, and a language proficiency score indicating how familiar a viewing user is with the language of the video. The subtitle context system then identifies words of the video that are likely difficult for the viewing user to understand by comparing the difficulty scores to a difficulty score threshold.

For words having associated difficulty scores that satisfy the difficulty score threshold, the subtitle context system determines that the viewing user's comprehension of the video would likely benefit from additional information describing a meaning of the word in the context of the video. Thus, in response to determining that a word's difficulty score satisfies a difficulty score threshold, the subtitle context system is configured to ascertain a definition of the word and one or more synonyms for the word. After identifying contextual information in the form of definitions and/or synonyms, the subtitle context system generates context-aware video subtitles, which include the part of speech tags, difficulty scores, definitions, and synonyms for difficult to understand words. The subtitle context system is further configured to play back the video together with the context-aware video subtitles in a context-aware subtitle interface. To do so, the subtitle context system generates the context-aware video subtitles with included start and end timecodes for each word and any associated contextual information, indicating when the words and the contextual information are to be displayed during playback of the video.

In this manner, the context-aware subtitle interface includes a display of the video's visual content along with subtitle words for the video. The subtitle words are displayed and removed from display according to their start and end timecodes, such that a subtitle word is displayed in the context-aware subtitle interface upon determining that a playback duration of the video corresponds to the start timecode for the word and removed from display upon determining that a playback duration of the video corresponds to the end timecode for the word. When a playback duration of the video reaches a point that corresponds to a start timecode for a word having a difficulty score that satisfies the difficulty score threshold, the context-aware subtitle interface is configured to display contextual information for the word that assists a viewing user in understanding a specific meaning of the word as used in the video. As described herein, this contextual information may include a display of a definition and/or a synonym for the word.

In some implementations, the contextual information is automatically displayed in the context-aware subtitle interface. Alternatively or additionally, the context-aware subtitle interface may display words having difficulty scores that satisfy a difficulty score threshold in a manner that visually distinguishes the words from other words of the video subtitles having associated difficulty scores that do not satisfy the difficulty score threshold. In this manner, the context-aware subtitle interface indicates to a viewing user that the visually emphasized word is associated with additional contextual information that can be displayed by the context-aware subtitle interface. In response to detecting input at such a word, the context-aware subtitle interface may output one or more pieces of contextual information for the word.

Thus, the techniques described herein enable generation of context-aware video subtitles that include contextual information for certain words that are determined to be difficult for a particular viewing user to understand. Contextual information of the context-aware video subtitles is output together with playback of the video such that the viewing user does not need to pause or otherwise interrupt playback of the video to understand a meaning of a subtitle word. In this manner, the techniques described herein provide contextual information for subtitles of the video in real-time during video playback while reducing inefficiencies present in conventional video playback systems.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ the context-aware video subtitle techniques described herein.

FIG. 2 illustrates an example implementation in which a subtitle context system of FIG. 1 generates context-aware video subtitles and a context-aware subtitle interface using techniques described herein.

FIG. 3 illustrates an example implementation of context-aware video subtitles generated by the subtitle context system of FIG. 1.

FIG. 4 illustrates an example implementation of context-aware video subtitles generated by the subtitle context system of FIG. 1.

FIG. 5 is a flow diagram depicting a procedure in an example implementation for generating difficulty scores for subtitles using the techniques described herein.

FIG. 6 is a flow diagram depicting a procedure in an example implementation for displaying context-aware video subtitles using the techniques described herein.

FIG. 7 is a flow diagram depicting a procedure in an example implementation for displaying context-aware video subtitles using the techniques described herein.

FIG. 8 illustrates an example system including various components of an example device that can be implemented as a computing device as described and/or utilized with reference to FIGS. 1-7 to implement the techniques described herein.

### DETAILED DESCRIPTION

### Overview

With advances in computing technology, videos have become ubiquitous, such that computing device users regularly encounter various forms of video in their daily lives. For instance, users regularly view news and sports videos, attend online educational courses, participate in videoconferences, communicate with friends via video messages, watch movies for entertainment, and so forth. With these advances in computing technology, videos are now available for viewing by a diverse audience spanning different geographic locations. For instance, local television broadcasts can frequently be streamed online at any location and are no longer geographically restricted to local broadcasts. As a result, users are frequently exposed to videos that include dialogue in an unfamiliar language. Because videos are frequently viewed with muted audio, video creators often include subtitles to textually describe dialog and other audible information expressed during playback of the video. Although subtitles are useful in assisting users understand the video, the subtitles' utility extends only to users who are familiar with the language in which the subtitles are written.

Conventional approaches to generating a video that can reach a more diverse audience include generating multiple versions of video subtitles, such that a video may be played back with options to display subtitles in English, Spanish, or various other languages. However, translating subtitles into different languages remains a time-intensive process. Furthermore, each version of video subtitles requires extra computational resources to store and communicate over a content delivery pipeline. As such, video creators are discouraged from creating videos that include subtitles to accommodate every known language and often only include subtitles for a single or select few languages to minimize computational resources required to store, transmit, and play back the video.

Video subtitles remain an essential tool for viewing users who are unfamiliar with the language of the video to understand dialog. For instance, a viewing user who is unfamiliar with the English language may wish to view and understand a video that includes dialog and subtitles in only English. To do so, the viewing user may play back the video while both listening to the video's audio and reading text of the video's subtitles. Using conventional video playback systems, the viewing user may be forced to pause the video upon encountering a word in the video subtitles with which the user is unfamiliar in order to research the word and understanding its meaning. In an example scenario where the viewing user is watching the video in full-screen mode on their computing device, conventional systems require the user to exit the full-screen viewing mode, open a new web browser tab or window, and search for a definition of the word before returning to the full-screen mode and resuming playback of the video. This process of pausing, researching, and resuming the video often causes users to lose interest in the video, interrupts the intended flow of the video, and consequently decreases overall user engagement with the video.

Furthermore, this separate research required by conventional systems offers no guarantee that the viewing user will identify the correct definition for a word as it is used in the context of the video. For instance, consider an example scenario where a protagonist in a movie is on a sailboat and yells “duck!” to another character on the boat. A viewing user who is unfamiliar with the English language, or the specific meaning of the word “duck”, may be forced to pause the movie, consult a dictionary, and identify that the word duck is a noun that refers to a particular type of bird. Having read and understood this definition, the viewing user may return to resume viewing the movie and anticipate that the protagonist's use of “duck” means that an animal will be introduced or otherwise have some importance in the context of the movie scene. However, the word “duck” in the context of the movie scene may instead refer to a warning from the protagonist that the boom of the sailboat is coming towards the other character, and that the other character will need to crouch down to avoid being struck by the boom. In this scenario, the viewing user who is unfamiliar with English may not identify that “duck” may be used as either a verb or a noun, and fail to understand the intended meaning of the dialogue. When no waterfowl appears in the scene, the viewing user is then forced to rewind the movie, further consult the dictionary to identify what the protagonist meant by “duck!”, and subsequently resume viewing the movie, resulting in user frustration.

Thus, there is a need to generate video subtitles with associated contextual information to assist viewing users who are not familiar with the video's language in comprehending the video's message during uninterrupted playback of the video.

Accordingly, subtitle context techniques and systems are described. In one example, a subtitle context system receives video subtitles, extracts words from the subtitles, and determines a part of speech describing each word's use in the video. Upon determining a part of speech for each word in the text file, the subtitle context system determines a difficulty score for each of the words. As described herein, the difficulty score for a given word in the text file is particular to a viewing user, such that generating difficulty scores for a single word may result in two different difficulty scores for two different viewing users. To generate a word's difficulty score, the subtitle context system considers a length of the word, a frequency at which the word is used in the language of the video, and a language proficiency score indicating a level of familiarity between a viewing user and the language of the video. The language proficiency score may be determined based on a geographic location of the user, based on stored user profile information indicating a preferred language, based on monitored user interactions, combinations thereof, and so forth. Thus, the subtitle context system is configured to compute word difficulty scores in a manner that is particular to a viewing user, such that the viewing user is presented with contextual information for subtitles as needed for that unique individual to understand the meaning of words in a video.

The subtitle context system then identifies words of the video that are likely difficult for the viewing user to understand by comparing the difficulty scores to a difficulty score threshold. For words having associated difficulty scores that satisfy the difficulty score threshold, the subtitle context system determines that the viewing user's comprehension of the video would likely benefit from additional information describing the meaning of the word in the context of the video. Thus, in response to determining that a word's difficulty score satisfies a difficulty score threshold, the subtitle context system is configured to ascertain a definition of the word and one or more synonyms for the word. After identifying contextual information in the form of definitions and/or synonyms, the subtitle context system generates context-aware video subtitles, which include the part of speech tags, difficulty scores, definitions, and synonyms for the subtitle words, with associated start and end timecodes. The subtitle context system is further configured to play back the video together with the context-aware video subtitles in a context-aware subtitle interface.

The context-aware subtitle interface includes a display of the video's visual content along with video subtitle words. The subtitle words are displayed, and removed from display, according to their start and end timecodes. Using these start and end timecodes, a subtitle word is displayed in the context-aware subtitle interface upon determining that a playback duration of the video corresponds to the start timecode for the word and removed from display upon determining that a playback duration of the video corresponds to the end timecode for the word. When a playback duration of the video reaches a point that corresponds to a start timecode for a word having a difficulty score that satisfies the difficulty score threshold, the context-aware subtitle interface is configured to display contextual information to assist a viewing user in understanding a meaning of the word. As described herein, this contextual information may include a definition and/or a synonym for the word. In some implementations, the contextual information is automatically displayed in the context-aware subtitle interface. Alternatively or additionally, the context-aware subtitle interface may display words having difficulty scores that satisfy the difficulty score threshold in a manner that visually distinguishes the words from other words of the video subtitles, which have associated difficulty scores that do not satisfy the difficulty score threshold. In this manner, the context-aware subtitle interface indicates to a viewing user that the visually emphasized word is associated with additional contextual information that can be displayed by the context-aware subtitle interface. In response to detecting input at such a word, the context-aware subtitle interface may output one or more pieces of contextual information for the word.

Thus, the techniques described herein enable generation of context-aware video subtitles that include contextual information for certain words that are determined to be difficult for a viewing user to understand. Contextual information of the context-aware video subtitles is output together with playback of the video such that the viewing user does not need to pause or otherwise interrupt playback of the video to understand a meaning of the word as used in the video. In this manner, the techniques described herein provide contextual information for subtitles of the video in real-time during video playback to provide a single interface for a user to view the video and understand meanings of words in the video, while reducing inefficiencies present in conventional video playback systems.

### Example Environment

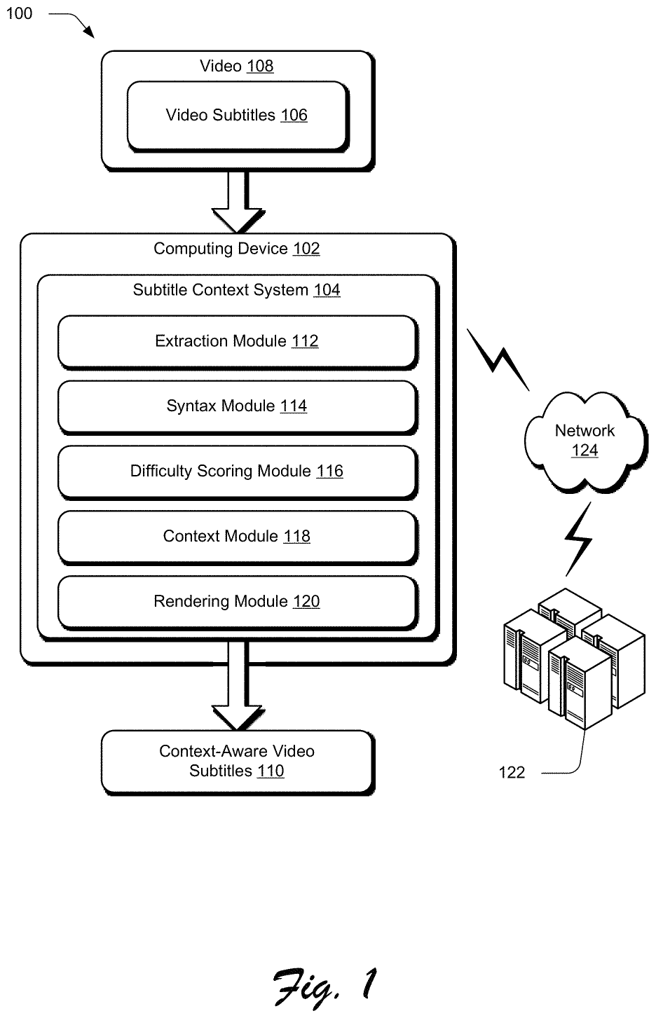

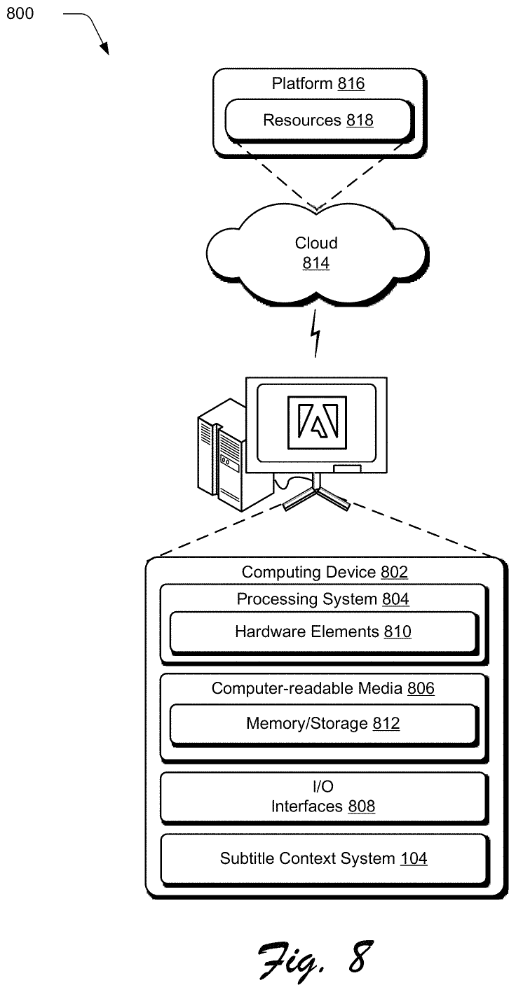

FIG. 1 is an illustration of a digital medium environment 100 in an example implementation that is operable to employ the techniques described herein. The illustrated environment 100 includes a computing device 102, which may be implemented in various configurations. The computing device 102, for instance, may be configured as a desktop computer, a laptop computer, a mobile device (e.g., assuming a handheld configuration such as a tablet or mobile phone), and so forth. Thus, the computing device 102 may range from a full resource device with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices, such as multiple servers to perform operations “over the cloud” as described with respect to FIG. 8.

The computing device 102 is illustrated as including a subtitle context system 104. The subtitle context system 104 represents functionality of the computing device to receive video subtitles 106 for a video 108 and generate context-aware video subtitles 110. As described in further detail below, the context-aware video subtitles 110 are representative of an instance of the video subtitles 106 that include additional contextual information for one or more words of the video subtitles 106, such as definitions, synonyms, combinations thereof, and so forth. Using the techniques described herein, the subtitle context system 104 is configured to generate the context-aware video subtitles 110 in a manner that accounts for a language proficiency level of a user viewing the video 108. In this manner, contextual information for individual words of the video subtitles 106 can be selectively displayed in response to determining that a word of the video subtitles 106 is difficult for a particular user viewing the video to understand.

The video subtitles 106 may be received as part of the video 108, such as included in metadata of a film, a television program, a video game, an advertisement, combinations thereof, and so forth. As described herein, the video subtitles 106 are representative of textual information derived from either a transcript or a screenplay of the video 108. Thus, the video subtitles 106 are representative of dialog, commentary, descriptive captioning to assist users who are hard-of-hearing in following audible aspects of the video 108, combinations thereof, and the like. The video subtitles 106 and the video 108 can be obtained by the computing device 102 in any suitable manner. For example, the video subtitles 106 and the video 108 may be obtained by from a different computing device, from storage local to the computing device 102, may be obtained together, may be obtained independent of one another, and so forth.

To generate the context-aware video subtitles 110, the subtitle context system 104 employs an extraction module 112, a syntax module 114, a difficulty scoring module 116, a context module 118, and a rendering module 120. The extraction module 112, the syntax module 114, the difficulty scoring module 116, the context module 118, and the rendering module 120 are each implemented at least partially in hardware of the computing device 102 (e.g., through use of a processing system and computer-readable storage media), as described in further detail below with respect to FIG. 8.

Upon receiving the video 108, the extraction module 112 is configured to extract the video subtitles 106 from the video 108. For instance, in accordance with one or more implementations where the video 108 is formatted as supporting SubRip, the video subtitles 106 may be formatted as a SubRip Subtitle, or “.srt” file. When formatted as a SubRip Subtitle file, the video subtitles 106 include words along with start and end timecodes to ensure that words of the video subtitles 106 are output in a synchronized manner with audio of the video 108. In these implementations, the extraction module 112 is configured to translate the video subtitles 106 from their SubRip Subtitle format to a text file format and transcribe individual timed subtitles, or captions, into individual strings of text. In this manner, the extraction module 112 is configured to generate a text file that includes each word of the video subtitles 106, along with timing information describing when each word of the video subtitles 106 is to be displayed during playback of the video 108.

After generating the text file that includes each word of the video subtitles 106 with their associated timing information, the subtitle context system 104 provides the text file to the syntax module 114. The syntax module 114 is configured to analyze the words of the video subtitles 106 included in the text file and assign a word class, or lexical category, to each of the words. In this manner, the syntax module 114 is configured to classify each of the words included in the video subtitles to identify how particular words are being used in the framework of the video 108. For instance, the syntax module 114 may analyze a word based on its relationship with adjacent and related words in a phrase, sentence, or paragraph, and may further consider the context of a word based on its definition. In some implementations, the syntax module 114 is configured to employ a rule-based part of speech tagging algorithm. Alternatively or additionally, the syntax module 114 is configured to employ a stochastic part of speech tagging algorithm. After identifying an appropriate part of speech for each word included in the video subtitles 106, the syntax module 114 updates the text file generated by the extraction module 112 to include a part of speech tag for each word in the text file.

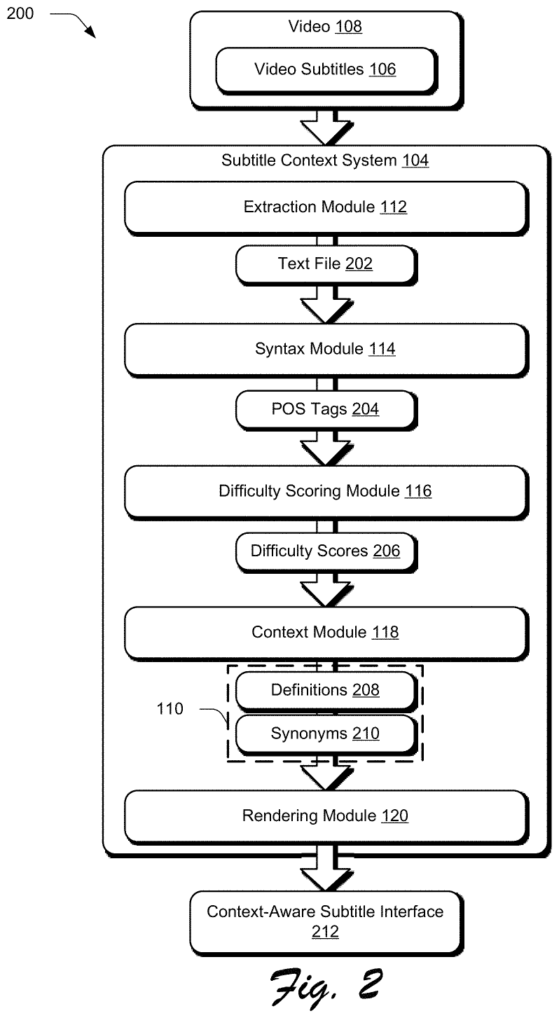

The text file with associated part of speech tags is then communicated to the difficulty scoring module 116. The difficulty scoring module 116 is configured to determine a difficulty score for each word included in the text file. To do so, the difficulty scoring module 116 considers three different factors for each word: (i) how frequently the word occurs in the language of the video 108; (ii) a length of the word; and (iii) a language proficiency score for a user viewing the video 108. Given these factors, the difficulty scoring module 116 is configured to generate numerical values indicating how difficult it is for a user viewing the video 108 to understand each word of the video subtitles 106. Computation of the difficulty scores is described in further detail below with respect to FIG. 2.

Upon computing a difficulty score for each word of the video subtitles 106, the subtitle context system 104 provides the words along with their associated difficulty scores and part of speech tags to the context module 118. The context module 118 is configured to determine a definition and one or more synonyms for each of the words included in the video subtitles 106. In some implementations, the context module 118 is configured to compare the difficulty scores to a difficulty score threshold and retrieve a definition and one or more synonyms for words having a difficulty score that satisfies the difficulty score threshold. Upon determining definitions and synonyms for the video subtitles 106, the subtitle context system 104 incorporates the words of the video subtitles 106 together with the definitions and synonyms determined by the context module 118 to generate the context-aware video subtitles 110. The context-aware video subtitles 110 include timestamps corresponding to each word in the video subtitles 106 indicating when the word is to be displayed during playback of the video 108. In a similar manner, the timestamps are associated with the definitions and synonyms identified by the context module 118.

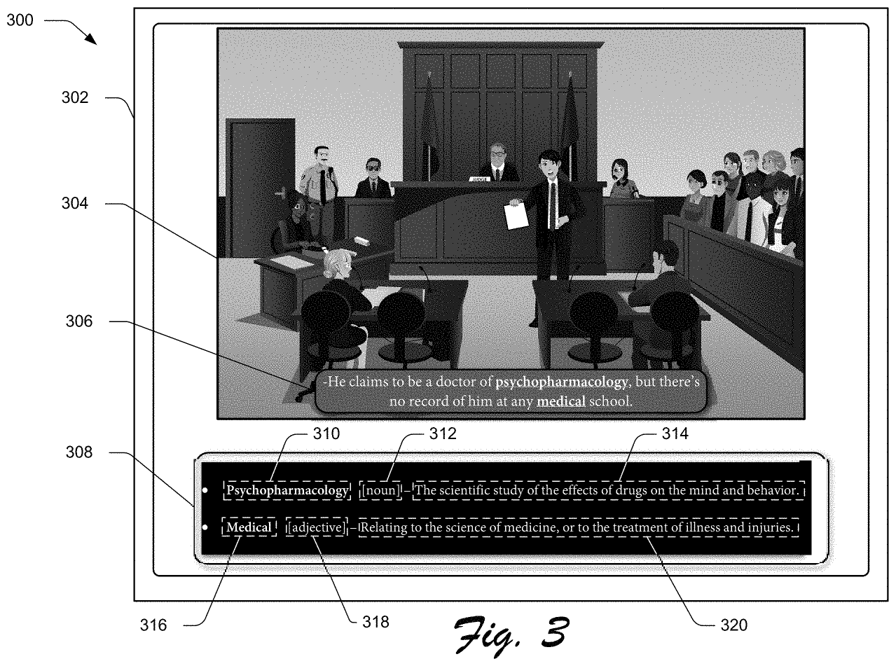

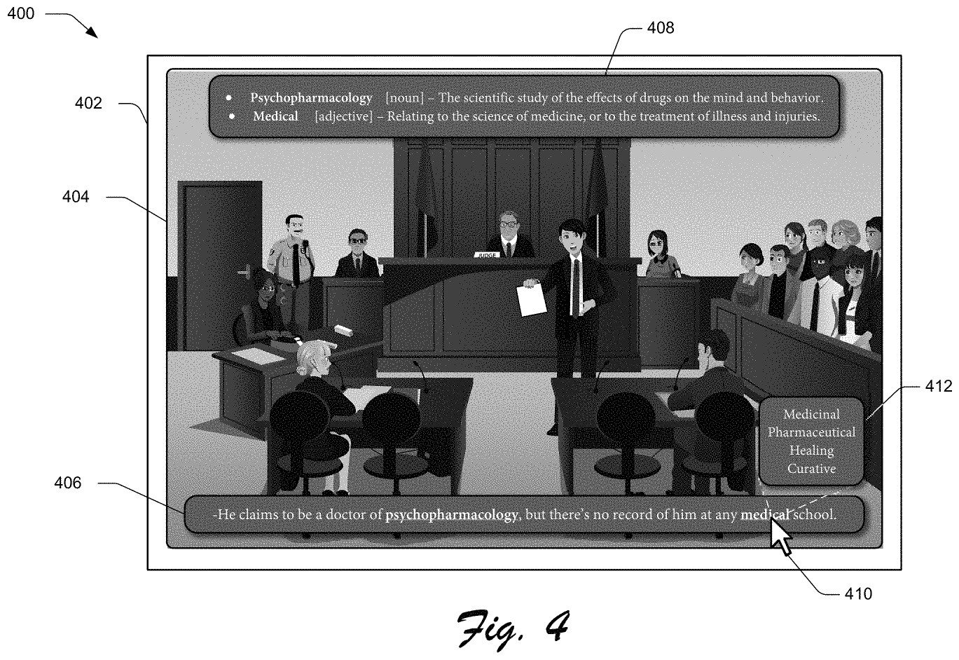

Given the context-aware video subtitles 110, the subtitle context system 104 is configured to play back the video 108 with the video subtitles 106 and the associated definitions and synonyms for words of the video subtitles 106 that are difficult to understand. For instance, the rendering module 120 may output a display of, or “play back,” the video 108 together with the context-aware subtitles 110 such that when a certain word that is difficult to understand is uttered during playback of the video 108, the rendering module 120 displays a definition and/or one or more synonyms for the word. Example displays of the video 108 and context-aware video subtitles 110 are described in further detail below with respect to FIGS. 3 and 4.

The context-aware subtitles 110 may be stored in storage of the computing device 102 together with the video 108, as described in further detail below with respect to FIG. 8. Alternatively or additionally, the subtitle context system 104 is configured to provide the context-aware video subtitles 110 and the video 108 to a remote storage location for subsequent retrieval and/or access by the computing device 102 or different computing devices. For instance, the subtitle context system 104 may communicate the context-aware subtitles 110 to remote storage 122, or directly to a different computing device, via network 124.

Having considered an example digital medium environment, consider now a discussion of an example system usable to generate and output a display of context-aware video subtitles in accordance with aspects of the disclosure herein.

FIG. 2 illustrates an example system 200 usable to generate a context-aware subtitle interface 212 that includes a display of context-aware video subtitles 110 in accordance with the techniques described herein. In the illustrated example, system 200 includes modules of the subtitle context system 104 as described with respect to FIG. 1, e.g., extraction module 112, syntax module 114, difficulty scoring module 116, context module 118, and rendering module 120. System 200 may be implemented on any suitable device or combination of devices. In one example, system 200 is implemented on one computing device (e.g., computing device 102 of FIG. 1). In another example, system 200 is implemented on more than one computing device, as described in further detail below with respect to FIG. 8.

In the example system 200, the subtitle context system 104 receives the video subtitles 106. In accordance with one or more implementations, the subtitle context system 104 receives the video subtitles 106 as part of the video 108, such as included in metadata of a film, a television program, a video game, an advertisement, combinations thereof, and so forth. As described herein, the video subtitles 106 are representative of textual information derived from either a transcript or a screenplay of the video 108. Thus, the video subtitles 106 are representative of dialog, commentary, descriptive captioning to assist users who are hard-of-hearing in following audible outputs of the video 108, combinations thereof, and the like. The video subtitles 106 and the video 108 can be obtained by the computing device in any suitable manner. For example, the video subtitles 106 and the video 108 may be obtained by from a different computing device, from storage local to the computing device 102, may be obtained together, may be obtained independent of one another, and so forth. In one or more implementations, the video subtitles 106 are received as a SubRip Text file, which includes subtitle words for the video 108 along with start and end timecodes designating when the subtitle words are to be output during playback of the video 108.

Upon receiving the video subtitles 106, the extraction module 112 extracts one or more words from the video subtitles 106 into text file 202. In an example implementation where the video subtitles 106 are included in a SubRip Text file, the extraction module 112 converts the SubRip Text file into text file 202. In this manner, the text file 202 is representative of a written rendering of dialog of the video 108 and/or additional information to assist viewers who are hard of hearing to follow the dialog and other audible aspects of the video 108. The extraction module 112 is further configured to include start and end timecodes within the text file 202, such that each word in the text file 202 is associated with information indicating when individual words, phrases, sets of dialog, combinations thereof, and so forth are to be displayed during playback of the video 108.

After generating the text file 202, the extraction module 112 communicates the text file 202 to syntax module 114. Syntax module 114 is configured to analyze the text file 202 to identify a part of speech (POS) for each word in the text file 202, such as to identify whether a particular word is used as a noun, a verb, an adjective, an adverb, and so forth in the context of the video 108. To do so, the syntax module 114 is configured to apply a natural language processing algorithm capable of disambiguating among multiple part of speech possibilities for a word in the text file 202. For instance, the syntax module 114 may apply statistical natural language processing, may apply rule-based natural language processing, deep learning natural language processing, combinations thereof, and so forth to identify and assign parts of speech to each word in the text file 202. In some implementations, the syntax module 114 may apply the Stanford Log-linear Part-Of-Speech Tagger to the text file 202 to identify parts of speech for words in the text file 202. For each word in the text file 202, the syntax module 114 generates a POS tag 204, which includes information describing what part of speech the word represents in the context of the video 108. In some implementations, the syntax module 114 may update the text file 202, such that each word in the text file 202 includes information describing its part of speech along with its start and end timecodes.

After generating the POS tags 204, the syntax module 114 communicates the text file 202 and the POS tags 204 to the difficulty scoring module 116. The difficulty scoring module 116 analyzes the text file 202 and determines a difficulty score for each word included in the text file. To do so, the difficulty scoring module 116 considers three different factors for each word: (i) how frequently the word occurs in the language of the video 108; (ii) a length of the word; and (iii) a language proficiency score for a user viewing the video 108.

As described herein, the difficulty scoring module 116 may determine a frequency at which a particular word occurs, or is used in, a language of the video 108 by consulting one or more word frequency lists that describe how often individual words appear in one or more text corpora. In this manner, the difficulty scoring module 116 ascertains a likelihood that a viewing user is familiar with a particular word in the video 108 based on a probability that the viewing user has previously encountered the word. A frequency ranking for how often a particular word occurs in the language of the video 108 is proportional to the difficulty score for the word. For instance, in an example scenario where the video 108 is in the English language, the word “family” occurs at a greater frequency than the word “frightened”. In implementations, the difficulty scoring module 116 may assign a numerical value representing a frequency with which a word is used, such as assigning 150 to the word “family” and 6000 to the word “frightened”, indicating that the words are the 150th and 6000th most often used words in the English language, respectively. As described in further detail below with respect to Equation 1, the numerical value indicating the word's usage frequency is proportional to its resulting difficulty score.

In addition to the word's frequency of usage in the language of the video 108, the difficulty scoring module 116 is configured to generate a difficulty score for each word included in the text file 202 based on the word's length. As described herein, the length of a word refers to a number of characters included in the word, such that the word “family” has a length of six and the word “frightened” has a length often. Because a viewing user of the video 108 is less likely to engage, or be familiar, with words that are longer in length, a difficulty score for a word is proportional to its length, as described in further detail below with respect to Equation 1.

The difficulty scoring module 116 is further configured to determine a difficulty score for each word included in the text file 202 based on a language proficiency score for a user viewing the video 108. To do so, the difficulty scoring module 116 identifies a geographic location at which the video 108 is to be played back. For instance, the difficulty scoring module 116 may identify a geographic location associated with a computing device implementing the subtitle context system 104, such as the computing device 102 of FIG. 1. Alternatively or additionally, the difficulty scoring module 116 may identify a geographic location at which the video 108 is to be played back based on stored user profile information for a viewing user.

For example, the difficulty scoring module 116 may identify that a computing device at which the video 108 is to be played back is located in Germany. Using this information, the difficulty scoring module 116 may determine that a viewing user's primary language is German. Continuing this example, the difficulty scoring module 116 may further determine that a user profile logged into the computing device located in Germany includes a home location of Delhi and a language preference of Hindi. The difficulty scoring module 116 may use the language preference indicated in the user profile instead of the geolocation, such that the user's language proficiency score is computed based on the user's preferred language of Hindi rather than German. In this manner, the difficulty scoring module 116 is configured to identify a language with which a viewing user is most comfortable, based on a locale of the viewing user and/or designated user preferences. In addition to determining a geographic location associated with a viewing user, the difficulty scoring module 116 is configured to determine a language of the video 108. The difficulty scoring module 116 may identify a language of the video 108 in any suitable manner, such as by analyzing metadata included in the video 108 or the video subtitles 106, analyzing words of the text file 202, and so forth.

Given the language of the video 108 and the geographic location associated with a viewing user, or computing device playing back the video, the difficulty scoring module 116 is configured to determine a language proficiency score for use in assigning difficulty scores to words of the text file 202. For instance, consider an example scenario where the video subtitles 106 are in the English language and the difficulty scoring module 116 identifies that a geographic location of a viewing user is Delhi, India. To identify an English language proficiency score for the user located in Delhi, the difficulty scoring module 116 is configured to consult one or more language proficiency indexes, which may be stored in a computing device implementing the subtitle context system 104, or may be stored in a location that is remote from the computing device implementing the subtitle context system 104.

The difficulty scoring module 116 may consult a language proficiency index for the English language, such as the English Proficiency Index generated by Education First, which includes a ranking of geographic locations according to the average level of English proficiency of the geographic location's citizens. Such a language proficiency index may provide a language proficiency ranking, indicating that citizens of China are less proficient than citizens of Canada at comprehending English, that citizens of India are more proficient than citizens of France at comprehending English, and so forth. In this manner, a lower language proficiency ranking value (e.g., Sweden is ranked “1”) may indicate a greater language proficiency than a higher language proficiency ranking value (e.g., Uzbekistan is ranked “86”), thus the language proficiency ranking value is proportional to a resulting difficulty score for a word (e.g., the same word may be more difficult for users in Uzbekistan to understand relative to users in Sweden).

In some implementations, the difficulty scoring module 116 is configured to dynamically update a language proficiency score for a particular user by monitoring user interactions with various forms of digital content over time. For instance, continuing the example implementation where a viewing user is associated with a geographic location of India, the difficulty scoring module 116 may determine from the English Proficiency Index that India is ranked 28th in a global ranking of countries and regions. However, the difficulty scoring module 116 may ascertain that the viewing user frequently accesses online articles written in English, receives emails written in English, and so forth. In this manner, the difficulty scoring module may determine that an appropriate language proficiency score for the viewing user should be ranked higher than the ranking of 28th otherwise assigned to the viewing user's region. Alternatively, the difficulty scoring module 116 may identify that a viewing user is less proficient in a given language than other users associated with a similar geographic region and adjust the language proficiency value to a lower ranking that more accurately represents the user's language proficiency.

Given these three values indicating a length of a word, a frequency of the word as used in the language of the video 108, and a language proficiency ranking value for a user viewing the video 108, the difficulty scoring module 116 is configured to generate a difficulty score for each word included in the text file 202. In accordance with one or more implementations, the difficulty scores may be generated according to Equation 1:

D_{score}=wₐ(l)+w_{b}(f)+w_{c}(p) (Eq. 1)

In Equation 1, “D_{score}” represents the difficulty score calculated for each word of the text file 202, “l” is a value representing the length of the word, “f” is a value representing a usage frequency ranking of the word in the language of the video 108, and “p” is a value representing a language proficiency ranking for a user viewing the video 108. In this manner, the length of a word, the frequency ranking of the word occurring in the language of the video 108, and the language proficiency ranking for a user viewing the video 108 are each proportional to a resulting difficulty score for a word.

The values representing the length of the word, the usage frequency ranking of the word, and the language proficiency ranking for the viewing user may further be mathematically weighted by the difficulty scoring module 116 to adjust a degree with which the respective values affect a resulting word difficulty score, as indicated by the respective weights “wₐ”, “w_{b}”, and “w_{c}”. In some implementations, the weights may be selected based on the respective values indicating the length and frequency ranking of the word, as well as the value representing the language proficiency ranking for the user. For instance, if the word's length is determined to exceed a threshold length value (e.g., the word is longer than eight characters), the difficulty scoring module 116 may increase a value of the weight wₐ, relative to a value that might be used for words having seven or fewer characters.

Similarly, the difficulty scoring module 116 may increase a value of the weight w_{b} in response to determining that the usage frequency ranking for a word satisfies a usage frequency threshold. For instance, the 50 most frequently used words of a language may be assigned a low weight w_{b}, the 51st to the 100th most frequently used words of the language may be assigned a middle weight w_{b}, and words outside the top-100 may be assigned a high weight w_{b}. Likewise, the w_{c} weight for the language proficiency ranking value may be assigned a dynamic value based on the associated language proficiency, such that words of the text file 202 will be assigned higher difficulty scores for viewing users who are determined to be unfamiliar with the language of the video 108. In some implementations, after computing the difficulty scores 206, the difficulty scoring module 116 is configured to normalize the difficulty scores 206 (e.g., such that the difficulty score of a given word can be expressed on a scale from zero to one).

After generating difficulty scores 206 for the words included in the text file 202, the difficulty scoring module 116 provides the text file 202, the POS tags 204, and the difficulty scores 206 to the context module 118. The context module 118 is then configured to determine which words in the text file 202 have associated difficulty scores that satisfy a difficulty score threshold. The difficulty score threshold may be any suitable value and may be specified in any suitable manner, such as pre-designated by the subtitle context system 104, specified by a user of a computing device implementing the subtitle context system 104, retrieved by the context module 118 from a user profile, and so forth. In some implementations, the difficulty score threshold may be determined based on a location of the computing device implementing the subtitle context system 104, such as computing device 102 of FIG. 1. In this manner, the difficulty score threshold may be dynamically adjusted such that it is lower in regions that are not associated with the language of the video 108 and higher in regions that are associated with the language of the video 108. Upon identifying the difficulty score threshold value, the context module 118 identifies words of the text file 202 having associated difficulty scores 206 that satisfy the difficulty score threshold value (e.g., having difficulty scores that are greater than and/or equal to the difficulty score threshold value).

For each word of the text file 202 having a difficulty score 206 that satisfies the difficulty score threshold value, the context module 118 identifies one or more definitions 208 for the word. In some implementations, the context module 118 disambiguates among multiple potential definitions 208 for a particular word by leveraging the corresponding POS tag 204 for the word to ensure that the definition 208 corresponds to the correct part of speech in which the word is used. Alternatively or additionally, the context module 118 may identify one or more synonyms 210 for each word of the text file 202 having a difficulty score 206 that satisfies the difficulty score threshold value. In some implementations, the context module 118 identifies one or more synonyms 210 for a word based on the POS tag 204 for the word, thereby ensuring that the definitions and synonyms for a word are appropriate for the context of the word's usage in the video 108.

After identifying the definitions 208 and the synonyms 210, based on the POS tags 204, for words of the text file 202 having difficulty scores 206 that satisfy a difficulty score threshold, the context module 118 updates the text file 202 to include the definitions 208 and the synonyms 210. Together with the POS tags 204, the difficulty scores 206, the definitions 208, and the synonyms 210 the updated text file 202 comprises the context-aware video subtitles 110, as indicated by the dashed outline in FIG. 2. The context-aware video subtitles 110 are then communicated to a rendering module 120, which is configured to output the context-aware video subtitles 110 concurrently with playback of the video 108. To do so, the rendering module 120 visually displays words of the text file 202 according to their respective start and end timecodes as indicated in the original video subtitles 106 in a context-aware subtitle interface 212. For each word of the text file 202 having an associated definition 208 and/or synonym 210, the rendering module 120 is configured to visually display at least one of the definition 208 or the synonym 210 in order to provide additional information describing how the word is used in the context of the video 108.

In accordance with one or more implementations, the rendering module 120 is configured to display the definition 208 beginning at the start timecode for the word and cease display of the definition 208 at the end timecode for the word in the context-aware subtitle interface 212. Alternatively, in some implementations the rendering module 120 is configured to display the definition 208 beginning at the start timecode for the word and maintain display of the definition 208 for a specified duration beyond the end timecode for the word with which the definition 208 is associated. The specified duration may be any suitable length of time (e.g., ten seconds), may be pre-designated by the subtitle context system 104, may be specified by a user of the subtitle context system 104, may be ascertained from stored user profile information, and so forth. In this manner, the rendering module 120 is configured to maintain a display of contextual information for words of the video subtitles 106 to ease a viewing user's comprehension of the word as used in the video 108. In a similar manner, the synonym 210 for a word may be displayed concurrently with the definition 208. Alternatively, the rendering module 120 may output a display of the synonym 210 for a word in response to receiving input at the word (e.g., detecting a user selection of the word via a cursor click, a cursor hover, a touch input, a gesture input, combinations thereof, and so forth).

To inform a user viewing the video 108 that particular words of the context-aware video subtitles 110 have additional information to provide context regarding their use in the video 108, the rendering module 120 is further configured to display words having associated difficulty scores 206 that satisfy the difficulty score threshold in a manner that is visually distinct from other words of the context-aware video subtitles. For instance, difficult to understand words may be highlighted, displayed in a different color, bolded, italicized, underlined, visually distinguished using combinations thereof, and so forth in the context-aware subtitle interface 212. In implementations where multiple words of the context-aware video subtitles 110 having associated definitions and/or synonyms are concurrently displayed during playback of the video 108, the rendering module 120 is configured to display the word, its definition, and one or more synonyms 210 in a visually similar manner. For instance, in an example scenario where the rendering module 120 simultaneously outputs display of three difficult to understand words, the rendering module may display one of the words, its definition, and one or more synonyms in a first color, display a second one of the words, its definition, and one or more synonyms in a second color, and the third one of the words, its definition, and one or more synonyms in a third color. In this manner, the rendering module 10 provides an intuitive correlation between a word and its contextual information so that a viewing user can readily identify which information is associated with which word, and avoid confusion that otherwise might arise by attributing a definition 208 or synonym 210 for a first word to a second word.

The rendering module 120 is further configured to monitor user interaction with the context-aware subtitle interface 212 to dynamically modify the context-aware video subtitles 110 and resulting display in the context-aware subtitle interface 212. For instance, the rendering module 120 may extend a display duration of the definitions 208 and synonyms 210 in response to detecting that a user repeatedly pauses playback of the video 108 while definitions 208 and synonyms 210 are displayed, which may be indicative of a user needing additional time to understand subtitle context. Similarly, in response to detecting a repeated pattern of a user interacting with difficult to understand words of the context-aware video subtitles 110, such as clicking on the words to prompt display of the synonyms 210, the rendering module 120 may update the context-aware subtitle interface 212 to automatically display synonyms 210 for words of the text file 202 having difficulty scores 206 that satisfy a difficulty score threshold. In a similar manner, the rendering module 120 may track user interaction with the context-aware subtitle interface 212 to adjust difficulty scoring weights for a particular user viewing the video.

For instance, in response to detecting that a user repeatedly interacts with difficult to understand words or repeatedly pauses playback of the video 108 while contextual information (e.g., definitions 208 and/or synonyms 210) is displayed in the context-aware subtitle interface 212, the subtitle context system 104 may instruct the difficulty scoring module 116 to increase one or more mathematical weights of Equation 1. By increasing these mathematical weights, a greater amount of words in the text file 202 will have resulting difficulty scores 206 that satisfy the difficulty score threshold. Alternatively, in response to detecting that a user does not pause playback of the video 108 while contextual information is being displayed in the context-aware subtitle interface 212, or in response to detecting that a user does not interact with difficult to understand words to view synonyms 210, the subtitle context system 104 may interpret that a user is becoming more familiar with the language of the video 108. For users who are familiar with the language of the video 108, contextual information in the form of definitions 208 and synonyms 210 may be distracting and unwanted. In such a scenario, the subtitle context system 104 is configured to instruct the difficulty scoring module 116 to decrease mathematical weights used in Equation 1, such that fewer words of the text file 202 will have resulting difficulty scores 206 that satisfy the difficulty score threshold.

Having considered an example system 200, consider now a discussion of example context-aware subtitle interfaces 212 that include displays of a video 108 and context-aware video subtitles 110 in accordance with one or more aspects of the disclosure.

FIG. 3 illustrates an example implementation 300 of the subtitle context system 104 generating a context-aware subtitle interface 212 that includes a display of a video and context-aware subtitles 110, which are generated for the video using the techniques described herein. The illustrated example includes an output of the context-aware subtitle interface 302 at a display of a computing device, such as computing device 102 as illustrated in FIG. 1. The context-aware subtitle interface 302 includes a display of a video's visual content 304, such as visual content of the video 108, as illustrated in FIGS. 1 and 2. In addition, the context-aware subtitle interface 302 includes subtitles 306 for the video, which are representative of context-aware video subtitles 110, which are generated from video subtitles 106 for the video 108 using the techniques described herein. In the illustrated example, the subtitles 306 for the visual content 304 recite “He claims to be a doctor of psychopharmacology, but there's no record of him at any medical school.” The words “psychopharmacology” and “medical” are illustrated as being displayed in a manner that is visually distinct from other words of the subtitles 306, which is indicative of a determination by the subtitle context system 104 that “psychopharmacology” and “medical” are likely difficult to understand for a user viewing the video 108.

For each of the difficult to understand words, the context-aware subtitle interface 302 includes additional contextual information 308, which in the illustrated example includes definitions for each of the words identified by the subtitle context system 104 as difficult to understand. Specifically, the contextual information 308 includes an identifier 310 for the word “psychopharmacology”, a part of speech indicator 312 indicating that “psychopharmacology” is being used as a noun in the context of the video 108, and a definition 314 for the word. In addition, the contextual information 308 includes an identifier 316 for the word “medical”, a part of speech indicator 318 indicating that “medical” is being used as an adjective in the context of the video 108, and a definition 320 for the word. This data included in the contextual information 308 is thus representative of information included in the text file 202, the POS tags 204, and the definitions 208, which are generated by the subtitle context system 104 as described with respect to FIG. 2.

The context-aware subtitle interface 302, visual content of the video 304, context-aware subtitles 306, and contextual information 308 may be output for display by the rendering module 120 of the subtitle context system 104. In implementations, the rendering module 120 is configured to output the contextual information 308 upon detecting that corresponding words of the context-aware subtitles 306 are to be output based on start and end timecodes for the words, as indicated in the text file 202. In some implementations, the rendering module 120 is configured to maintain a display of the contextual information 308 even after the corresponding words “psychopharmacology” and “medical” are no longer being displayed in the context-aware subtitles 306. In this manner, the contextual information 308 is not limited to display times dictated by a pace of dialogue or scene transitions in a video, which provides a viewing user additional time to comprehend words of the video that are difficult to understand without having to pause the video or consult a separate source of information. A duration during which the contextual information 308 remains displayed in the context-aware subtitle interface 302 may span any length of time, and may further be customized by a viewing user to fit their needs.

To further mitigate confusion regarding which of the part of speech indicators 312 and 318 and which of the definitions 314 and 320 correlate to a given word in the subtitles 306, the contextual information 308 may be configured to display information for the given word in a manner similar to how the given word is displayed in the subtitles 306. For instance, in an example scenario where “psychopharmacology” is displayed in the subtitles 306 in red text, contextual information 308 pertaining to “psychopharmacology” may also be displayed in red text. In this example scenario, the identifier 310, the part of speech indicator 312, and the definition 314 would also be displayed in red text. Similarly, if in the example scenario “medical” is displayed in the subtitles 306 in blue text, contextual information 308 pertaining to “medical” may also be displayed in blue text. Specifically, the identifier 316, the part of speech indicator 318, and the definition 320 would also be displayed in blue text. Thus, the contextual information 308 is displayed in a manner that readily enables a viewer of the video 108 to identify which contextual information 308 correlates to a particular word in the subtitles 306, even if the viewer is unfamiliar with the particular word or the source language of the particular word.

Although the example implementation 300 illustrates the contextual information 308 as being displayed apart from a display of the video's visual content 304, in other implementations it is preferable to display the contextual information 308 within the borders of the video's visual content 304. Such an implementation may be particularly desirable when playback of a video is performed on a computing device having a small form factor (e.g., a mobile phone).

FIG. 4 illustrates an example implementation 400 of the subtitle context system 104 generating a context-aware subtitle interface 212 that includes a display of a video and context-aware video subtitles, such as video 108 and context-aware video subtitles 110 generated using the techniques described herein. The illustrated example includes an output of the context-aware subtitle interface 402 at a display of a computing device, such as computing device 102 as illustrated in FIG. 1. The context-aware subtitle interface 402 includes a display of a video's visual content 404, such as visual content of the video 108 described and illustrated with respect to FIGS. 1 and 2. In addition, the context-aware subtitle interface 402 includes subtitles 406 for the video, which are representative context-aware video subtitles 110, generated from video subtitles 106 for the video 108 using the techniques described herein. In the illustrated example, the subtitles 406 for the visual content 404 recite “He claims to be a doctor of psychopharmacology, but there's no record of him at any medical school.” The words “psychopharmacology” and “medical” are illustrated as being displayed in a manner that is visually distinct from other words of the subtitles 406, which is indicative of a determination by the subtitle context system 104 that “psychopharmacology” and “medical” are likely difficult to understand for a user viewing the video 108.

For each of the difficult to understand words, the context-aware subtitle interface 402 includes additional contextual information 408 and 412, which in the illustrated example includes definitions for each of the words identified by the subtitle context system 104 as difficult to understand and synonyms for a selected one of the difficult to understand words.

Specifically, the contextual information 408 includes an identifier for the word “psychopharmacology”, a part of speech indicator indicating that “psychopharmacology” is being used as a noun in the context of the video 108, and a definition “psychopharmacology”. In addition, the contextual information 408 includes an identifier for the word “medical”, a part of speech indicator indicating that “medical” is being used as an adjective in the context of the video 108, and a definition for “medical”. This data included in the contextual information 408 is thus representative of information included in the text file 202, the POS tags 204, and the definitions 208, which are generated by the subtitle context system 104 as described with respect to FIG. 2.

The example implementation 400 is further illustrated as including a cursor 410, which is representative of user input at the context-aware subtitle interface 402. The cursor may be manipulated by one or more input/output devices of a computing device displaying the context-aware subtitle interface 402, as described in further detail below with respect to FIG. 8. In some implementations, the cursor 410 may not be visibly displayed with the context-aware subtitle interface 402, such as in an example scenario where the context-aware subtitle interface 402 is output at a touchscreen configured to receive touch-based inputs without need for displaying a cursor to indicate a position of a pointing device.

In the example implementation 400, the cursor 410 is positioned over the word “medical”, as displayed in the subtitles 406. In response to detecting input at one of the words of the subtitles 406 that is identified by the subtitle context system 104 as difficult to understand, the subtitle context system 104 is configured to output a display of one or more synonyms for the word in the contextual information 412. Thus, in the illustrated example, the subtitle context system 104 outputs a display of four synonyms for the word “medical”, specifically “medicinal”, “pharmaceutical”, “healing”, and “curative”. The synonyms included in contextual information 412 are thus representative of the synonyms 210 identified by the context module 118. In some implementations, the synonyms included in contextual information 412 are automatically displayed by the subtitle context system 104 upon determining that corresponding words of the subtitles 406 are to be output based on their respective start and end timecodes indicated in the text file 202. The context-aware subtitle interface 402, visual content 404 of the video, context-aware subtitles 406, and contextual information 408 and 412 may be output for display by the rendering module 120 of the subtitle context system 104.

In some implementations, the rendering module 120 is configured to maintain a display of the contextual information 408 and 412 even after the corresponding words “psychopharmacology” and “medical” are no longer being displayed in the context-aware subtitles 406. In this manner, the contextual information 408 and 412 is not limited to display times dictated by a pace of dialogue or scene transitions in a video, which provides a viewing user additional time to comprehend words of the video that are difficult to understand without having to pause the video or consult a separate source of information. A duration during which the contextual information 408 and 412 remains displayed in the context-aware subtitle interface 402 may span any length of time, and may further be customized by a viewing user to fit their needs.

As described above with respect to FIG. 3, to further mitigate confusion regarding which contextual information 408 and 412 corresponds to a given word in the subtitles 406, the contextual information 408 and 412 may be displayed in a manner similar to how the given word is displayed in the subtitles 406. For instance, in an example scenario where “psychopharmacology” is displayed in the subtitles 406 in bold, italicized font, a portion of the contextual information 408 corresponding to “psychopharmacology” may also be displayed in bold, italicized font. Likewise, if in the example scenario “medical” is displayed in a different color than other words of the subtitles 406, a portion of the contextual information 408 corresponding to “medical” and the synonyms of the contextual information 412 may be displayed using the same color used to display “medical” in the subtitles 406. Thus, the contextual information 408 and 412 is displayed in a manner that readily enables a viewer of the video 108 to identify which contextual information, or portion thereof, correlates to a particular word in the subtitles 406, even if the viewer is unfamiliar with the particular word or the source language of the particular word.

Having considered example details of techniques for generating a context-aware subtitle interface that includes context-aware subtitles for a video, consider now some example procedures to illustrate aspects of the techniques.

### Example Procedures

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference may be made to FIGS. 1-4.

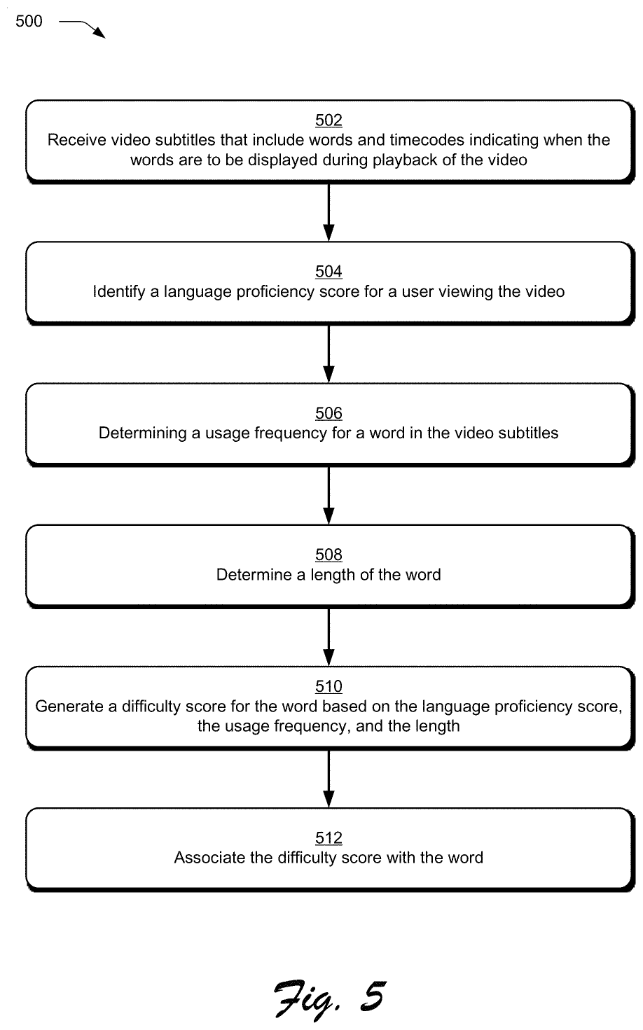

FIG. 5 depicts a procedure 500 in an example implementation of generating a difficulty score for a word included in video subtitles using the techniques described herein. Video subtitles that include words and timecodes indicating when the words are to be displayed during playback of the video are received (block 502). The computing device implementing the subtitle context system 104, for instance, receives video subtitles 106. In some implementations, the subtitle context system 104 receives the video subtitles 106 as embedded in the video 108 and is configured to extract the video subtitles 106 into a text file 202 using the extraction module 112. The text file 202 generated by the extraction module 112 includes words of the video subtitles 106 and respective e start and end timecodes indicating when the words are to be output for display during playback of the video 108.

A language proficiency score for a user viewing the video is then identified (block 504). The difficulty scoring module 116 of the subtitle context system 104, for instance, identifies a geographic location at which the video 108 is to be played back. For instance, the difficulty scoring module 116 may identify a geographic location associated with a computing device implementing the subtitle context system 104, such as the computing device 102 of FIG. 1. Alternatively or additionally, the difficulty scoring module 116 may identify a geographic location at which the video 108 is to be played back based on stored user profile information for a viewing user. In addition to determining a geographic location associated with a viewing user, the difficulty scoring module 116 is configured to determine a language of the video 108. The difficulty scoring module 116 may identify a language of the video 108 in any suitable manner, such as by analyzing metadata included in the video 108 or the video subtitles 106, analyzing words of the text file 202, and so forth. Given the language of the video 108 and the geographic location associated with a viewing user, or computing device playing back the video, the difficulty scoring module 116 is configured to determine a language proficiency score for the viewing user by consulting a language proficiency index to identify a language proficiency score, which may be expressed in terms of a ranking, for the viewing user relative to the language of the video 108.

A usage frequency for a word included in the video subtitles is then determined (block 506). The difficulty scoring module 116, for instance, consults one or more word frequency lists that describe how often individual words appear in one or more text corpora for the language of the video 108. In this manner, the difficulty scoring module 116 ascertains a likelihood that a viewing user is familiar with a particular word in the video 108 based on a probability that the viewing user has previously encountered the word. The usage frequency for the word may be expressed in terms of a ranking, such that a most frequently used word in the language of the video is ranked “one”, the second most frequently used word in the language of the video is ranked “two”, and so forth. A length of the word is then determined (block 508). The difficulty scoring module 116, for instance, analyzes the word and determines a number of characters included in the word, such that the word “family” has a length of six and the word “frightened” has a length of ten.

A difficulty score for the word is then generated based on the language proficiency score, the usage frequency of the word, and the length of the word (510). The difficulty scoring module 116, for instance, may compute a difficulty score 206 for a given word in the video subtitles 106 according to Equation 1, where optionally weighted mathematical values corresponding to the language proficiency score, the usage frequency, and the length are summed with one another. In some implementations, the weights may be selected based on the respective values indicating the length and frequency ranking of the word, as well as the value representing the language proficiency ranking for the user. In some implementations, after computing the difficulty scores 206, the difficulty scoring module 116 is configured to normalize the difficulty scores 206, (e.g., such that the difficulty score of a given word can be expressed on a scale from zero to one). The difficulty score is then associated with the word (block 512). The difficulty scoring module 116, for instance, updates the text file 202 to include the computed difficulty score 206 as being connected to a particular word in the text file 202.

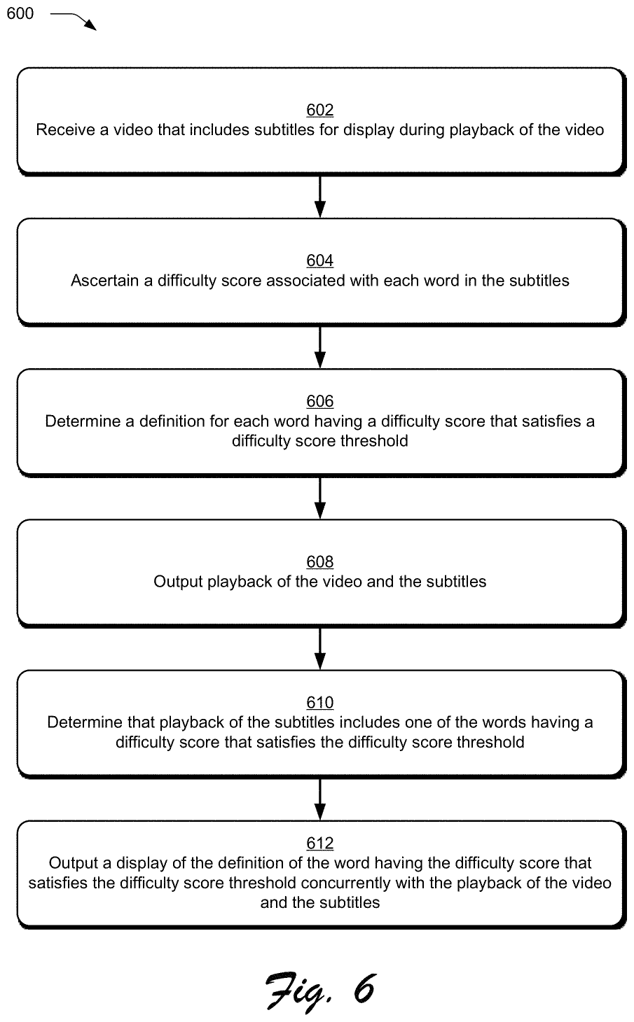

FIG. 6 depicts a procedure 600 in an example implementation of outputting a display of contextual information for video subtitles using the techniques described herein. A video that includes subtitles for display during playback of the video is received (block 602). The computing device implementing the subtitle context system 104, for instance, receives video subtitles 106. In some implementations, the subtitle context system 104 receives the video subtitles 106 as embedded in the video 108 and is configured to extract the video subtitles 106 into a text file 202 using the extraction module 112. The text file 202 generated by the extraction module 112 includes words of the video subtitles 106 and respective e start and end timecodes indicating when the words are to be output for display during playback of the video 108.

A difficulty score associated with each word in the subtitles is ascertained (block 604). The difficulty scoring module 116, for instance, may generate difficulty scores 206 for each word in the text file 202, as described above in the procedure 500. Upon ascertaining difficulty scores for each word, a definition for each word having a difficulty score that satisfies a difficulty score threshold is determined (block 606). The context module 118, for instance, receives the difficulty scores 206 along with the text file 202 and the POS tags 204 from the difficulty scoring module 116. The difficulty score threshold may be any suitable value, and may be specified in any suitable manner, such as pre-designated by the subtitle context system 104, specified by a user of a computing device implementing the subtitle context system 104, retrieved by the context module 118 from a user profile, and so forth.

Upon identifying the difficulty score threshold value, the context module 118 identifies words of the text file 202 having associated difficulty scores 206 that satisfy the difficulty score threshold value (e.g., having difficulty scores that are greater than and/or equal to the difficulty score threshold value). For each word of the text file 202 having a difficulty score 206 that satisfies the difficulty score threshold value, the context module 118 identifies one or more definitions 208 for the word. In some implementations, the context module 118 disambiguates among multiple potential definitions 208 for a particular word by leveraging the corresponding POS tag 204 for the word to ensure that the definition 208 corresponds to the correct part of speech in which the word is used. Alternatively or additionally, the context module 118 may identify one or more synonyms 210 for each word of the text file 202 having a difficulty score 206 that satisfies the difficulty score threshold value. In some implementations, the context module 118 identifies one or more synonyms 210 for a word based on the POS tag 204 for the word, thereby ensuring that the definitions and synonyms for a word are appropriate for the context of the word's usage in the video 108.

Playback of the video and the video subtitles is then output (block 608). The rendering module 120, for instance, outputs a display of a context-aware subtitle interface 212, such as one of the example context-aware subtitle interfaces illustrated in FIGS. 3 and 4. The context-aware subtitle interface 212 may be output at a display device of a computing device implementing the subtitle context system, such as computing device 102 of FIG. 1. Alternatively or additionally, the context-aware subtitle interface 212 may be output at a display device of a computing device that is different from the computing device implementing the subtitle context system 104. The words of the context-aware video subtitles 110 are output synchronously with the video 108 based on their respective start and end timecodes.

A determination that playback of the video subtitles includes one of the words having a difficulty score that satisfies the difficulty score threshold is made (block 610). The rendering module 120, for instance, may identify a word as having a difficulty score that satisfies the difficulty score threshold in response to a playback duration of the video 108 elapsing to the start timecode for the word. In response to detecting that playback of the video subtitles includes a word having a difficulty score that satisfies the difficulty score threshold, a display of the definition of the word is output concurrently with the playback of the video and the video subtitles (block 612). The rendering module 120, for instance, visually displays a definition 208 for the word as indicated by the context-aware video subtitles 110 in the context-aware subtitle interface 212. The definition 208 for the word having an associated difficulty score 206 that satisfies the difficulty score threshold may be output in contextual information 308, as illustrated in FIG. 3, separate from visual content of the video 108. Alternatively, the definition 208 may be displayed in contextual information 408, as illustrated in FIG. 4, in a manner that visually occludes a portion of the visual content of the video 108. The rendering module 120 outputs the definition 208 at a point during playback of the video 108 that corresponds to the start timecode for the word. In accordance with one or more implementations, the rendering module 120 maintains display of the definition 208 in the context-aware subtitle interface 212 for a specified duration, which may optionally extend beyond the end timecode for the word, thereby providing additional time for a viewing user to read the definition and understand the word. In addition to displaying a definition for a difficult to understand word, the rendering module 120 is further configured to provide additional contextual information for the word in the form of one or more synonyms.

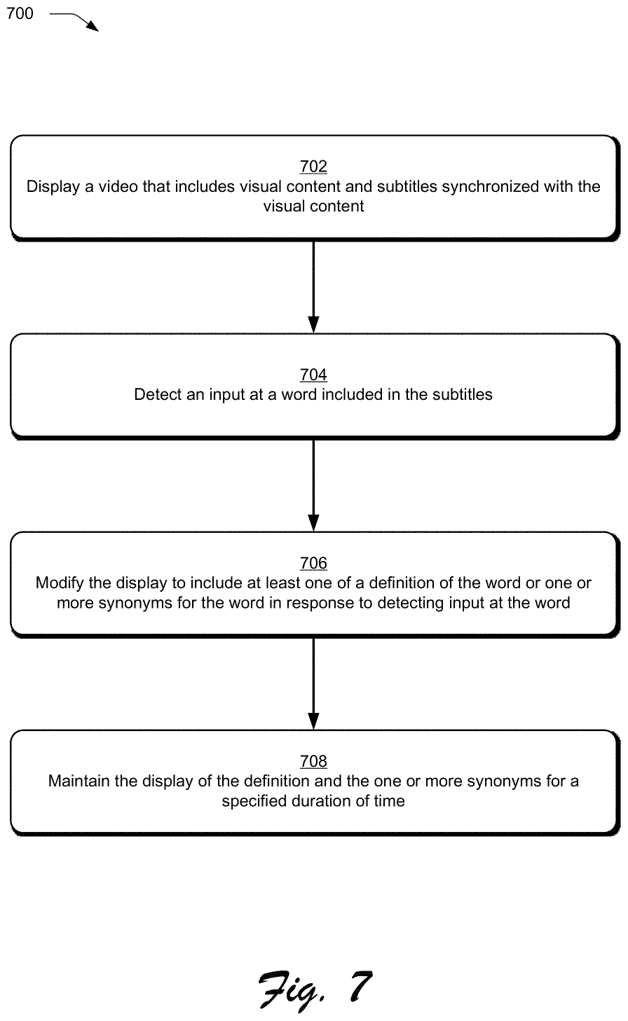

FIG. 7 depicts a procedure 700 in an example implementation of outputting a display of contextual information for video subtitle using the techniques described herein. A video that includes visual content and subtitles synchronized with the visual content is displayed (block 702). The rendering module 120, for instance, outputs a display of a context-aware subtitle interface 212, such as one of the example context-aware subtitle interfaces illustrated in FIGS. 3 and 4. The context-aware subtitle interface 212 may be output at a display device of a computing device implementing the subtitle context system, such as computing device 102 of FIG. 1. Alternatively or additionally, the context-aware subtitle interface 212 may be output at a display device of a computing device that is different from the computing device implementing the subtitle context system 104. The words of the context-aware video subtitles 110 are output synchronously with the video 108 based on their respective start and end timecodes.

An input at a word included in the video subtitles is detected (block 704). The rendering module 120, for instance, detects a user input to a word included in the subtitles 406 during playback of the video 108. The rendering module 120 may detect input to the word in any suitable manner, such as in response to a pointing device input, a cursor hovering over the word, a touch input, a gesture input, combinations thereof, and so forth. For example, the rendering module 120 may detect that the cursor 410 is hovering over the word “medical” as output in the subtitles 406 of FIG. 4.

In response to detecting input at the word, the display is modified to include at least one of a definition of the word or one or more synonyms for the word (block 706). The rendering module 120, for instance, outputs contextual information 408 and/or 412 in response to detecting input via cursor 410 to the word “medical” in the subtitles 406. The contextual information 408 and 412 include a definition 208 and one or more synonyms 210 for the word “medical”, respectively.

A display of the definition and/or synonym(s) for the word is maintained for a specified duration of time (block 708). The contextual information 408 and/or 412 may be displayed in the context-aware subtitle interface 212 for a specified duration, which may optionally extend beyond the end timecode for the word, thereby providing additional time for a viewing user to read the definition and/or synonyms and better understand the word.

Having described example procedures in accordance with one or more implementations, consider now an example system and device that can be utilized to implement the various techniques described herein.

### Example System and Device

FIG. 8 illustrates an example system generally at 800 that includes an example computing device 802 that is representative of one or more computing systems and/or devices that may implement the various techniques described herein. This is illustrated through inclusion of the subtitle context system 104. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 may include applications and/or data that can be utilized while computer processing is executed on servers that are remote from the computing device 802. Resources 818 can also include services provided over the Internet and/or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

### Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to provide contextual meaning for difficult words in video subtitles, a method implemented by at least one computing device, the method comprising:
receiving, by the at least one computing device, subtitles for a video, the subtitles including a plurality of words and a plurality of timestamps that indicate when the plurality of words are to be displayed during playback of the video;
identifying, by the at least one computing device, a language proficiency score associated with a user viewing the video, the language proficiency score indicating the user's ability to understand a language in which the subtitles are written;
determining, by the at least one computing device, for one of the plurality of words, a usage frequency of the word in the language in which the subtitles are written;
ascertaining, by the a least one computing device, a length of the word;
calculating, by the at least one computing device, a difficulty score for the word based on the usage frequency of the word, the length of the word, and the language proficiency score associated with the user; and
associating, by the at least one computing device, the difficulty score with the word.

2. The method as recited in claim 1, wherein calculating the difficulty score comprises assigning a mathematical weight to the length of the word based on a number of characters in the word, the mathematical weight being proportional to the number of characters in the word such that a longer word is assigned a greater mathematical weight than a shorter word.

3. The method as recited in claim 1, wherein determining the usage frequency of the word relative to the language in which the subtitles are written comprises identifying a rate of recurrence of the word to other words used in the language in which the subtitles are written, wherein calculating the difficulty score for the word comprises assigning a mathematical weight to the usage frequency based on the word's rate of recurrence, such that a more frequently used word is assigned a lesser mathematical weight than a less frequently used word.

4. The method as recited in claim 1, wherein identifying the language proficiency score comprises ascertaining a geographic location of a client device playing the video and using an English Proficiency Index value associated with the geographic location as the language proficiency score.

5. The method as recited in claim 1, wherein identifying the language proficiency score comprises identifying a preferred language associated with user profile information for the user viewing the video.

6. The method as recited in claim 1, further comprising, comparing, by the at least one computing device, the difficulty score to a difficulty score threshold and generating at least one synonym of the word for display during playback of the video responsive to determining that the difficulty score satisfies the difficulty score threshold.

7. The method as recited in claim 1, further comprising comparing, by the at least one computing device, the difficulty score to a difficulty score threshold and generating a definition of the word for display during playback of the video responsive to determining that the difficulty score satisfies the difficulty score threshold.

8. The method as recited in claim 7, further comprising outputting a display of the definition of the word during playback of the video in response to detecting that playback of the video has elapsed to a duration indicated by one of the plurality of timestamps associated with the word.

9. In a digital medium environment in which a computing device can provide contextual meaning for difficult words in video subtitles, one or more computer-readable storage media storing instructions that implement a subtitle context system which, responsive to execution by the computing device, perform operations comprising:
receiving a video, the video including subtitles that are displayed during playback of the video;
ascertaining, for each of a plurality of words included in the subtitles, a difficulty score associated with the word;
determining, for each of the plurality of words having a difficulty score that satisfies a difficulty score threshold, a definition for the word;
outputting playback of the video and the subtitles at a display device of the computing device; and
responsive to determining that one of the plurality of words having the difficulty score that satisfies the difficulty score threshold is being output during playback of the video, displaying the definition of the one of the plurality of the words concurrently with the video at the display device.

10. The computer-readable storage media as recited in claim 9, the operations further comprising maintaining the display of the definition of the one of the plurality of words during the playback of the video for a designated duration that extends beyond a point in the playback where the one of the plurality of words is no longer displayed as part of the subtitles.

11. The computer-readable storage media as recited in claim 9, the operations further comprising displaying the one of the plurality of words and the definition for the one of the plurality of words in a visually distinct manner that is different from other words of the subtitles.

12. The computer-readable storage media as recited in claim 9, wherein the difficulty score for the one of the plurality of words is computed based on a length of the one of the plurality of words, a usage frequency associated with the one of the plurality of words, and a language proficiency score associated with a user viewing the video, the language proficiency score indicating the user's ability to understand a language in which the subtitles are written.

13. The computer-readable storage media as recited in claim 9, wherein the difficulty score threshold is determined based on a location of the computing device.

14. The computer-readable storage media as recited in claim 9, wherein the difficulty score threshold is determined based on a user profile currently signed into the computing device.

15. The computer-readable storage media as recited in claim 9, the operations further comprising identifying a part of speech for the one of the plurality of words as it is used in the context of the video, wherein the definition is determined based on the part of speech.

16. A system having a subtitle context component to enable video subtitle contextualization, the system comprising:
a processing system; and
one or more computer-readable media having instructions stored thereon that are executable by the processing system to perform operations comprising:
outputting a display of a video at a display device, the display of the video including visual content of the video and subtitle words associated with the video;
detecting input at one of the subtitle words;
responsive to detecting the input at the one of the subtitle words, modifying the display to include one or more synonyms for the one of the subtitle words; and
maintaining the display of the one or more synonyms for a specified duration of time.

17. The system as recited in claim 16, the operations further comprising displaying the one of the subtitle words in a manner that is visually distinct from other words of the subtitles in response to determining that a difficulty score for the one of the subtitle words satisfies a difficulty score threshold.

18. The system as recited in claim 17, wherein the difficulty score for the one of the subtitle words is computed based on a length of the one of the subtitle words, a usage frequency associated with the one of the subtitle words, and a language proficiency score associated with a user viewing the video.

19. The system as recited in claim 16, the operations further comprising identifying a definition for the one of the subtitle words and modifying the display to include the definition for the one of the subtitle words concurrently with the one or more synonyms.

20. The system as recited in claim 16, wherein the specified duration of time extends beyond an end timecode for the one of the subtitle words during playback of the video, the end timecode indicating a point during playback at which the one of the subtitle words is to no longer be displayed.
